(19) United States
(12) Patent Application Publication
(10) Pub. No.: US 2004/0134435 A1
(43) Pub. Date: Jul. 15, 2004

(54) Squirrel guard for a bird feeder

(76) Inventors: Michael Martin Dunn, Concord, NH (US); John D. Ela, Concord, NH (US); Donald Edward Bigos, North Berwick, ME (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/340,902

(22) Filed: Jan. 10, 2003

(51) Int. Cl. A01K 61/02

(52) U.S. Cl. 119/52.3

(57) ABSTRACT

A dispenser guard for use in a bird feeder including a seed storage and a seed dispenser having a seed reservoir connected from the seed storage for receiving seed from the seed storage and allowing access to the seed. An upper guard plate extends across the seed reservoir and includes a first plurality of upper access openings and a lower guard plate is located between the upper guard plate and the seed reservoir and extends across the seed reservoir and includes a second plurality of lower access openings. The dimensions of the upper access openings and of the lower access openings and the distance between the upper guard plate and the lower guard plate are selected to prevent a squirrel from removing seed from the reservoir.

### FIELD OF THE INVENTION

The present invention relates to bird feeders and, in particular, to a bird feeder including protection for limiting or frustrating the theft of bird food by squirrels.

### BACKGROUND OF THE INVENTION

The feeding of birds is a widespread and popular practice for many reasons, including the conservation, management and encouragement of wildlife and the pleasure of observing the birds. As a result, a variety of bird feeder designs have been developed for these purposes, many of which are designed for specific purposes or to achieve particular objects and goals. For example, it is common for bird feeders to be designed to dispense a specific type of food in order to attract specific species of birds, or to be designed in such a way that only certain species of birds or birds having certain characteristics may obtain food from the feeder. In some feeders, for example, birds that can not easily cling are discouraged by designs without perches, larger birds are discouraged by limiting the dimensions of the access openings to accommodate only smaller species of birds. Some feeders, such as finch feeders, employ multiple methods for selecting preferred species of birds. For example, thistle seed is very attractive to finches and related or similar species of bird and both the seed and the birds are relatively small. In finch or thistle feeders, therefore, the feeding access holes in the seed container are corresponding small, thereby selecting for finches and related species of birds by both food preference and the size of the desired birds.

A common problem with bird feeders, however, is in preventing various forms of wildlife from eating the food, typically seed or suet mixtures, that is intended for the birds. Squirrels are widely recognized as a particularly severe problem in this respect and there are many bird feeder designs intended to foil squirrels by one method or another. For example, one of the most common methods is to provide some form of “unclimbable” barrier to prevent squirrels from reaching the feeder, such as a wide, smooth collar or dome around the pole or line supporting the feeder. A more complex method is feed opening shutter mechanism that closes off access to the food access openings under the greater weight of a squirrel while allowing access to the openings under the lesser weight of a bird. Still other methods involve sizing the food access openings or paths to exclude squirrels, which are typically larger than the desired birds.

All of these methods, however, are to at least a certain degree ineffective in one aspect or another. For example, squirrels are very adept and agile climbers and acrobats, have very dexterous paws, particularly the front paws, and are relatively intelligent for at least their own purposes. Because of this, squirrels are often able to bypass protective barriers by climbing over or around the barriers or by leaping from adjacent perches, are often able to reach the food openings without actuating shutter mechanisms, and can often reach through or around restricted openings to grasp the food. Another problem of the more complex forms of bird feeders is the mechanical complexity of, for example, protective barriers and shutter mechanisms. Such mechanisms significantly increase the manufacturing complexity and costs of the feeders, and often either fail in use or require significantly greater maintenance efforts.

The present invention provides a solution to these and other problems of the prior art.

### SUMMARY OF THE INVENTION

The present invention is directed to a dispenser guard for use in a bird feeder that includes a seed storage and a seed dispenser having a seed reservoir connected from the seed storage for receiving seed from the seed storage and allowing access to the seed. A guard includes an upper guard plate extending across the seed reservoir and including a first plurality of upper access openings and a lower guard plate located between the upper guard plate and the seed reservoir and extending across the seed reservoir and including a second plurality of lower access openings. The dimensions of the lower access openings are less than the dimensions of the upper access openings and the dimensions of the lower access openings and the distance between the upper guard plate and the lower guard plate and are selected to prevent a squirrel from removing seed from the reservoir. In a preferred embodiment, however, the dimensions of the upper and lower access openings and the distance between the upper guard plate and the lower guard plate are selected to allow a desired species of bird access to the seed in the seed reservoir.

The dimensions of the upper access openings are selected to be less than the shoulder width of an average squirrel while the dimensions of the lower access openings are less than the dimensions of the upper access openings. The dimensions of the lower access openings and the distance between the upper guard plate and the lower guard plate and are selected according to the forearm length of an average squirrel to prevent an average squirrel either from separating its paws to grasp a seed when thrust through an upper access opening and a lower access opening or from avoiding enclosing a section of the guard between the squirrel's arms.

In a present embodiment, the lower access openings are arranged into at least one third plurality of lower access openings, each third plurality of lower access openings corresponding to an upper access opening and the dimensions of each third plurality of lower access openings corresponds to the dimensions of the corresponding upper access opening. Each third plurality of lower access openings is located vertically below the corresponding upper access opening and the upper access openings are arranged as one or more groups of upper access openings while the third pluralities of lower access openings are arranged as one or more corresponding groups of third pluralities of lower access openings.

A squirrel guard includes an upper guard plate and a lower guard plate. The upper guard plate includes a first upper guard plate panel extending across the seed reservoir and including a first plurality of upper access openings and a second upper guard plate panel extending at an upward angle from the first guard plate panel and forming a side wall of the seed container. The lower guard plate includes a first lower guard plate panel and a second lower guard plate panel. The first lower guard plate panel is located between the first upper guard plate panel and the seed reservoir, extends across the seed reservoir, and includes a second plurality of lower access openings. The second lower guard plate panel extends upwards from the first lower guard plate panel and forms a side wall extension wherein a top edge of the side wall extension is attached to a bottom edge of the side wall, and a gap between a bottom edge of the side wall extension and the reservoir floor plate forms a seed flow path from the seed container into the reservoir.

In the present embodiment, each side wall of the seed container has at least one window opening each end wall of the seed container has a window bracket for engagingly retaining a transparent panel against an inner surface of the side wall and a sidewall bracket for engagingly retaining an upper edge of the side wall and the transparent panel against the window bracket. Each guard is fabricated as a single unit with a container side wall and the upper guard plate includes a first upper guard plate panel that extends across the seed reservoir and the second upper guard plate panel forms a side wall of the seed container. The lower guard plate includes a first lower guard plate panel that extends across the seed reservoir between the first upper guard plate panel and the seed reservoir and has an outer edge removably engaging with an upper edge of the outer wall of the seed reservoir. A second lower guard plate panel extends downwards from the outer edge of the first lower guard plate panel to the reservoir floor plate and a third lower guard plate panel forms a side wall extension, a top edge of the side wall extension and is attached to a bottom edge of the side wall and formed into a bracket for engagingly retaining a lower edge of the transparent panel while a gap between a bottom edge of the side wall extension and the reservoir floor plate forms a seed flow path from the seed container into the reservoir.

A guard and container side wall unit are slidably and rotatingly engaged with the bird feeder by engagement of the upper edge of the side wall between a window bracket and a sidewall bracket, engagement of the outer edge of the first lower guard plate panel with the upper edge of the outer wall of the seed reservoir, and location of the transparent panel between the inner surface of the side wall and the window bracket and in contact with the window bracket to urge the top edge of the side wall into contact with the sidewall bracket, to urge the outer edge of the first lower guard plate into contact with the upper edge of the outer wall of the seed reservoir.

### BRIEF DESCRIPTION OF THE DRAWING(S)

The invention will now be described, by way of example, with reference to the accompanying drawings in which:

FIG. 1 is a diagrammatic representation of a generalized bird feeder;

FIG. 2 is an isometric representation of a bird feeder incorporating the present invention;

FIG. 3 is a cross sectional view of a squirrel guard of the present invention;

FIGS. 4 and 5 are isometric views of the upper and lower guard plates of a squirrel guard of the present invention; and

FIGS. 6A, 6B, 6C and 6D are diagrammatic views illustrating the operation of the present invention for various approaches by squirrels to obtain seeds.

### DETAILED DESCRIPTION OF THE INVENTION

A. General Description of a Typical Feeder 10

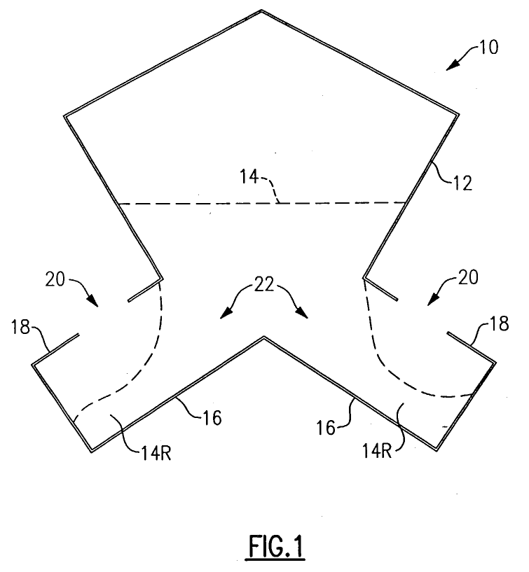

Referring to FIG. 1, therein is shown a generalized, diagrammatic view of a typical bird Feeder 10. As illustrated therein, a typical Feeder 10 includes a Seed Container 12 for holding a bulk quantity of Seed 14 and one or more Dispensers 16 connecting with Seed Container 12 for holding smaller quantities of Seed 14 and providing access to the Seed 14 in Dispensers 16 by birds in a manner to facilitate feeding by the birds. For this purpose, Dispensers 16 are typically dimensioned and shaped to provide a secure perch for the birds while feeding and the connection between Dispensers 16 and Seed Container 12 is such as to allow Seed 14 to flow steadily and constantly from Seed Container 12 to the Dispensers 16 in a controlled manner as the birds consume Seed 14. In this regard, Seed Container 12, Dispensers 16 and Flow Paths 22 must be dimensioned and shaped so that the approximate volume of Seed 14 in Dispensers 16 is relatively constant as the birds consume the Seed 14 from Dispenser 16, and so long as there is Seed 14 in Seed Container 12, while controlling the flow of Seed 14 into Dispensers 16 so that the Seed 14 does not, for example, overflow Dispensers 16 to be lost.

Dispensers 16 also commonly include other elements, dependent upon design choice and upon the specific features desired in the Feeder 10. For example, Dispensers 16 often include perches or perch areas designed to provide comfortable and secure perches for specific species or types of birds. Dispensers 16 may also include Access Covers 18 having Feeding Openings 20 similarly sized and positioned to facilitate feeding by the desired species or types of birds. The Seed Container 12, Dispensers 16, Flow Paths 22 and Feeding Openings 20 may also be sized and shaped according to a specific Seed 14 or type of Seed 14 that is to be dispensed from the Feeder 10.

As discussed, more complex Feeders 10 may include shutter mechanisms to exclude squirrels and birds above a desired size, while in simpler Feeders 10 the Dispensers 16 may be comprised of Feeding Openings 20 opening directly into the Seed Container 12 and having associated perches wherein the Feeding Openings 20 are sized to the desired species of birds and the Seed 14 to be dispensed.

B. General Structure of a Feeder 10

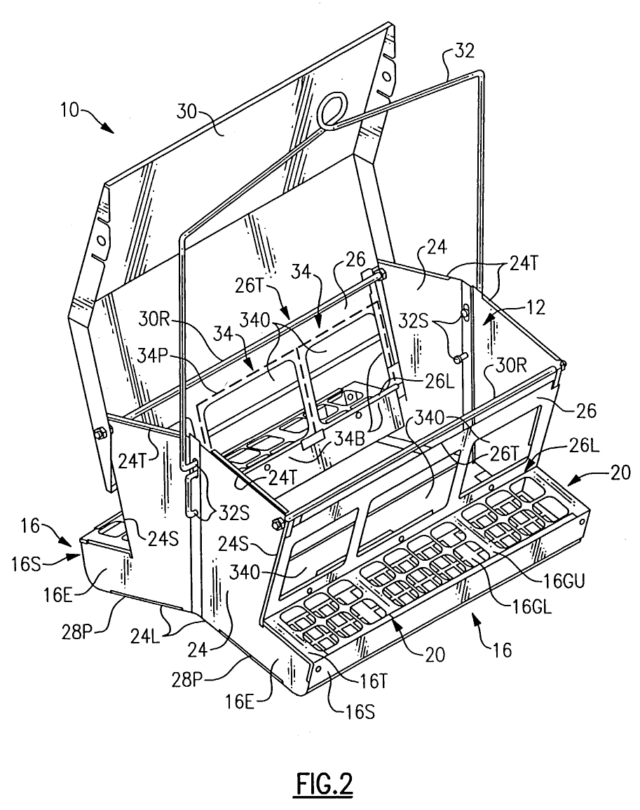

Referring now to FIG. 2, therein is illustrated an isometric view of a Feeder 10 incorporating the present invention. As generally represented therein, the Feeder 10 includes a Seed Container 12 having two End Walls 24 and two Side Walls 26. In the exemplary embodiment, each End Wall 24 is of a generally keystone shape with a Top Edge 24T rising from the tops of Side Edges 24S to a central peak and each Side Edge 24S sloping generally inwards and downwards from the intersection of the Side Edge 24S with Top Edge 24T. The Lower Edges 24L of End Walls 24 are similar in shape to the Top Edges 24T, extending downwards and outwards at a slant from a central peak vertically below the peak of the Top Edge 24T, thereby providing a slope along which Seed 14 flows from Seed Container 12 to Dispensers 16. As shown, End Walls 24 and the Lower Edges 24L of End Walls 24 extend outwards beyond the lower edges of Side Walls 26 to form End Walls 16E at each end of Dispensers 16, which are located along the lower portions of Side Walls 26 on each side of Seed Container 12.

Side Walls 26 of Seed Container 12 are of a generally horizontally elongated rectangular shape, each having a Top Edge 26T extending between the intersection of the Side Edge 24S with Top Edge 24T of one End Wall 24 and the corresponding side edge/top edge intersection of the other End Wall 24. The Lower Edge 26L of each Side Wall 26 extends between End Walls 24 and along the top of a Dispenser 16, so that the height of each Side Wall 26 is less than the height of End Walls 24. Seed Container 12 is thereby generally of an elongated rectangular shape, but having a cross section wherein the side walls extend inwards as well as downwards from the intersection of each side wall with the longitudinal top edge of the Seed Container 12 and wherein the end walls of the Seed Container 12 are generally vertical.

In the present embodiment, Feeder 10 includes a Dispenser 16 located along and extending outwards from the lower edge of each Side Wall 26 and extending the length of Seed Container 12, that is, the length of Side Walls 26. As will be discussed in further detail in a following detailed description, Seeds 14 are accessible to birds through Feeding Openings 20 formed in the top of each Dispenser 16. As will also be discussed further, a Flow Path 22 is provided between Seed Container 12 and Dispensers 16 and along the lower side portion of Seed Container 12 so that Seed 14 may slide along the downward slope formed by the Bottom Panel 28P extending along the bottom of Seed Container 12 and the sloping Lower Edges 24L of End Walls 24 as the Seed 14 is consumed from Dispensers 16.

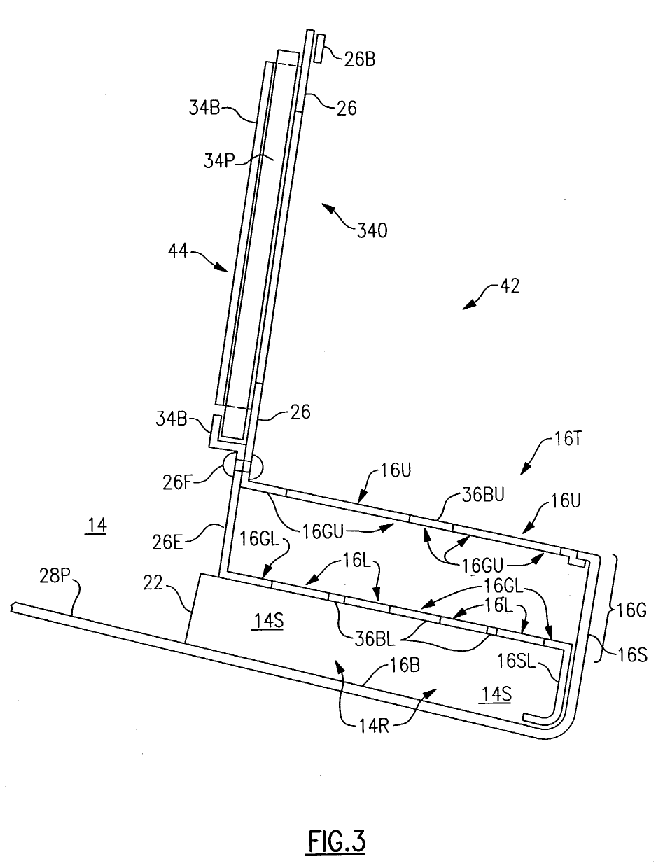

In this regard, it must be noted that the slope of Flow Path 22 along Bottom Panel 28 in FIGS. 1 and 3 is exaggerated for illustrative purposes. As discussed previously, however, Seed Container 12, Dispensers 16 and Seed Flow Paths 22 are intended to facilitate feeding by the birds and thereby to permit a steady and constant flow of Seed 14 from Seed Container 12 to Dispensers 16 as the Seed 14 is consumed by the birds. The slope of Flow Paths 22 are also shaped and sloped so as to control the flow of Seed 14 into Dispensers 16 so that the Seed 14 does not, for example, overflow Dispensers 16 to be lost. In addition, the related structural elements of a Feeder 1 0, such as Dispensers 16, Access Covers 18 and Feeding Openings 20 are to provide a comfortable and secure perch for the birds while feeding, which may effect the slope of Flow Paths 22. In a present embodiment, for example, the slope of Bottom Plates 28P and thus of Flow Paths 22 is approximately 150 from horizontal. It will be appreciated and understood, however, that this angle may be greater or lesser, depending for example on other dimensions of Flow Paths 22, Seed Container 12 and Dispensers 16, the type and dimensions of Seed 14, and so on.

As shown, End Walls 16E of Dispensers 16 are formed by the outward extensions of the lower portions of End Walls 24, thereby forming a continuous edge across the bottom of Seed Container 12 and Dispensers 16. Bottom Panel 28P extends longitudinally between End Walls 24 of Seed Container 12 and across the contiguous lower edges of End Walls 24 of Seed Container 12 and End Walls 16E of Dispensers 16, thereby forming the bottom of Feeder 10 and of Flow Paths 22. It will be noted that in the present embodiment of a Feeder 10, and as shown, the outer portions of Bottom Panel 28P may bend upwards to form the outer Dispenser Sidewallsl6S. In other embodiments, Dispenser Sidewalls 16S may be formed of separate panels, or of a downward extending outer portion of the top plate of each Dispenser 16.

The Feeder 10 is further provided with a Roof 30 which, in the present embodiment, is formed of a single, continuous panel. As shown, Roof 30 extends from End Wall 24 to End Wall 24 of Seed Container 12 and is bent along the longitudinal axis of Seed Container 12 to conform to the Top Edges 24T of End Walls 24 and to extend beyond the outer top corners of End Walls 24. Roof 30 thereby forms a peaked roof with eaves extending over both Side Walls 26S and at least portions of Dispensers 16. In addition, the ends of Roof 30 are preferably bent downwards along the outer side of the top edges of End Walls 24, thereby further protecting Seed 14 from the elements.

In the present embodiment, the Roof 30 panel is hinged or pivoted to the top of Seed Container 12 in any of a number of different ways. For example, and as illustrated, the downward extensions of the ends of the Roof 30 panel, that overlap the top edges of End Walls 24, are mounted onto End Walls 24 by means of a Rod 30R extending through both the downwards extensions of the Roof 30 panel at each end of Seed Container 12 and the top outer corners of End Walls 24. In this regard, it should be noted that Rod 30R functions as a structural support member for the Feeder 10, as well as a hinge for Root 30, and that for this purpose the Feeder 10 will preferably include a Rod 30R also joining the opposite top outer corners of End Walls 24. It will be appreciated and understood, moreover, that a Roof 30 may be constructed and mounted to the Feeder 10 in any of a number of ways which will be well known to and well understood by those of ordinary skill in the relevant arts, and that the structural functions of Rods 30R may be fulfilled in a number of ways.

The basic structure of a presently preferred embodiment of a Feeder 10 further includes a Hanger 32 by which the Feeder 10 may be suspended from a support, such as a tree, pole, building element, and so on. In the illustrated embodiment, Hanger 32 is comprised of a generally U-shaped wire element with the open side facing downward and a loop formed in the middle of the horizontal upper portion of the U for attachment from a support or suspension means. As shown, the two downward extending arms of Hanger 32 are shaped to lock or snap into appropriately shaped and located Suspension Mounts 32S in the Feeder 10, which may, and for example, be formed by keyed openings in End Walls 24 of Seed Container 12. In will be understood, however, that a Hanger 32 and Suspension Mounts 32S may be implemented in a number of forms well known to those of ordinary skill in the arts. It will also be understood that a Feeder 10 may be mounted or attached to a support attaching to or mating with the bottom of the Feeder 10, such as by a pole socket mounted in the center of Bottom Panel 28P.

Lastly with regard to the basic structure of a Feeder 10, it is shown that the present embodiment of Seed Container 12 include a plurality of Windows 34 comprised of one or more Window Openings 34O covered by one or more Transparent Plates 34P through which the Seed 14 in Seed Container 12 may be observed. Transparent Plates 34P are typically made of glass and are mounted in Brackets 34B wherein Brackets 34B, which will be discussed further, typically extend along three sides of the Transparent Plate 34P or Transparent Plates 34P of one or more Windows 34, that is, the bottom and two sides, so that each Transparent Plate 34P is removable for such purposes as cleaning or replacement. In a present preferred embodiment of a Feeder 10, Windows 34 are formed by ports or openings in a plate forming the walls of Seed Container 12 and a single Transparent Plate 34P extends along each side of Seed Container 12 to form the Windows 34 in each side of Seed Container 12. In this implementation, Brackets 34B will extend along the bottom and two ends of each of the Transparent Plates 34P. It will also be noted that Transparent Plates 34P may be made of other transparent or generally transparent materials, such as plexiglass, plastic, etc.

C. Structure of a Squirrel Guard of a Feeder

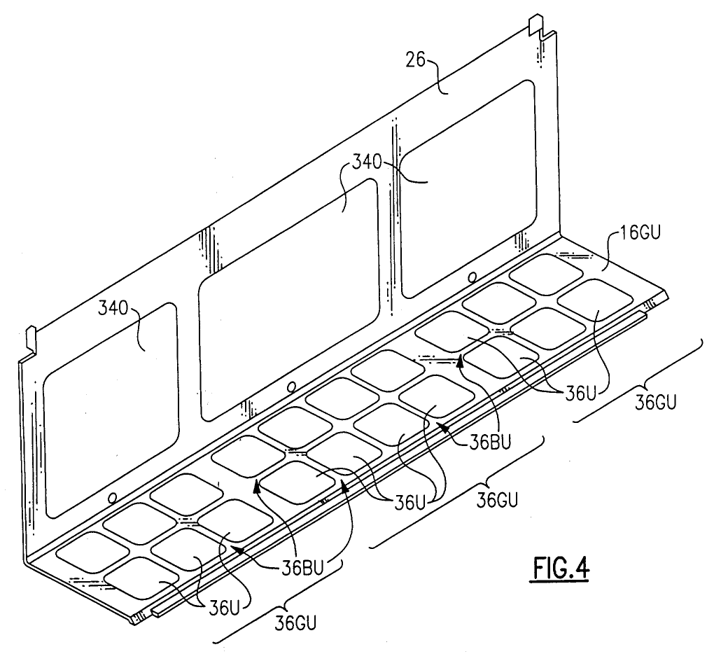

Referring again to Dispensers 16, FIG. 2 provides general, isometric views of the Guards 16G of the Dispensers 16 of a Feeder 10 while FIG. 3 is a cross sectional view of a Dispenser 16 and related portions of Seed Container 12. FIGS. 4 and 5, in turn, are isometric views of exemplary embodiments of Upper Guard Plate 16GU and Lower Guard Plate 16GL of a Guard 16G. The following descriptions will include dimensions for an exemplary embodiment of a Feeder 10 incorporating the present invention. It should be understood, however, that any stated dimensions are approximate and reasonable tolerances or modifications in the dimensions may be expected. That is, and for example, a stated dimension of one inch or one half inch may be approximate to within one quarter or one eighth inch, respectively. Also, the dimensions and shapes of a given implementation of a Feeder 10 incorporating the present invention may vary according to the choice and desire of the designer as the present invention does not in general depend upon specific dimensions, but on structural relationships and functions. For example, it will be described in the following that a squirrel guard of the present invention may have an upper guard and a lower guard separated by a height or space of one half inch; this dimension may vary from one half inch in other implementations, so long as the structural relationship and functions of the upper and lower guards are preserved.

As shown in FIGS. 2 and 3, each Dispenser 16 includes a Guard 16G to prevent the removal of Seed 14 from the Feeder 10 by undesired creatures, such as squirrels. A Guard 16G includes an Upper Guard Plate 16GU and a Lower Guard Plate 16GL that are spaced apart vertically. A Seed Supply 14S is located in Seed Reservoir 14R in the lower part of the Dispenser 16, between Lower Guard Plate 16GL and a Bottom Plate 16B of the Dispenser 16, which in the present implementation is formed by Bottom Panel 28P of Feeder 10. Seed Supply 14S is formed and replenished from Seed Container 12 by Seed 14 sliding downwards from Seed Container 12 and along a Flow Path 22 into the Dispenser 16, that is, along the sloping Bottom Plate 28P of Seed Container 12 and Bottom Plate 16B of the Dispenser 16. As discussed previously, in the exemplary implementation the slope of Bottom Plate 28P and Bottom Plate 16B is approximately 150 from horizontal, but this angle may vary within the functional requirements of providing a continuing flow of Seed 14 as Seed Supply 14S is depleted while preventing Seed Supply 14S from overflowing the Dispenser 16.

As shown in FIGS. 2, 3 and 4, the Seed Supply 14S in Seed Reservoir 14R is accessible through Upper Access Openings 36U and Lower Access Openings 36L in Upper Guard Plate 16GU and Lower Guard Plate 16GL, respectively, which form Feeding Openings 20. Upper Guard Plate 16GU includes a plurality of Upper Access Openings 36U which, in the presently preferred embodiment, are arranged into a plurality of Upper Opening Groups 36GU. In the exemplary embodiment shown, there are three Upper Opening Groups 36GU spaced along Upper Guard Plate 16GU, that is, along the longitudinal axis of the Dispenser 16. The two endmost Upper Opening Groups 36GU each include six Upper Access Openings 36U arranged as a two wide by three long grid and the middle Upper Opening Group 36GU includes eight Upper Access Openings 36U arranged as a two wide by four long grid. It will be noted, in this regard, that the terms “wide” and “width” refer to the dimension or direction running between the outer edge of a Dispenser 16 to the inner edge of the Dispenser 16, that is, from the outer side of Dispenser Sidewall 16S to the Side Wall 26 of the Seed Container 12. In a like manner, the term “long”, “along” or “length” refer to the distance or direction running between End Walls 16E of the Dispenser 16.

In the presently preferred embodiment of a Guard 16G, the Upper Access Openings 36U are generally square with rounded corners and are, for example, approximately 1 inch long, that is, as measured along the length of the Dispenser 16, by approximately 1 inch wide, as measured across the width of the Dispenser 16. Within each Upper Opening Group 36GU, the distance between an edge of one Upper Access Opening 36U and the same edge of an adjacent Upper Access Opening 36U as measured along the length of the Dispenser 16 is, for example, approximately 1 inch, and adjacent Upper Access Openings 36U within an Upper Opening Group 36GU are separated, in the direction along the Dispenser 16, by a Upper Separator Bar 36BU having a width of approximately 0.1 inch. In the direction measured across a Dispenser 16, that is, from Dispenser Sidewall 16S of the Dispenser 16 to the adjacent Side Wall 26 of the Seed Container 12, the distance between an edge of an Upper Access Opening 36U and the same edge of the adjacent Upper Access Opening 36U is approximately 1 inch, and adjacent Upper Access Openings 36U within an Upper Opening Group 36GU are separated, in the direction across the Dispenser 16, by a Upper Separator Bar 36BU having a width of approximately 0.1 inches. It should be noted, in this regard, that Upper Separator Bars 36U are comprised of the material of Upper Guard Plate 36GU remaining between the Upper Access Openings 36U after the Upper Access Openings 36U are cut out of the Upper Guard Plate 36GT, and effectively form a grid. Lastly, adjacent Upper Opening Groups 36GU are spaced apart along the length of the Dispenser 16 by approximately 0.5 inch, leaving a space of approximately 0.5 inch between each Upper Opening Group 36GU and the corresponding End Wall 16E.

Next referring to FIGS. 2, 3 and 5, a Lower Guard Plate 16GL extends along Dispenser 16 above Seed Reservoir 14R and includes a plurality of Lower Access Openings 36L which, in the presently preferred embodiment, are arranged into a plurality of Lower Opening Groups 36GL. In the exemplary embodiment shown, there are three Lower Opening Groups 36GL spaced along Lower Guard Plate 16GL, that is, along the longitudinal axis of the Dispenser 16. The two endmost Lower Opening Groups 36GL each include 24 Lower Access Openings 36L arranged as a four wide by six long grid and the middle Lower Opening Group 36GL includes 32 Lower Access Openings 36L arranged as a four wide by eight long grid. It will be noted in this regard, and again, that the terms “wide” and “width” refer to the dimension or direction running between the outer edge of a Dispenser 16 to the inner edge of the Dispenser 16, that is, from the outer Side Wall 16S of a Dispensers 16 to the Side Wall 26 of the Seed Container 12. In a like manner, the term “long”, “along” or “length” refer to the distance or direction running between End Walls 16E of the Dispenser 16.

In the presently preferred embodiment of a Guard 16G, the Lower Access Openings 36L are again generally square with rounded corners and are, for example, approximately 0.5 inch long, as measured along the length of the Dispenser 16, by approximately inches wide, as measured across the width of the Dispenser 16. Within each Lower Opening Group 36GL, the distance between an edge of one Lower Access Opening 36L and the same edge of an adjacent Lower Access Opening 36L as measured along the length of the Dispenser 16 is, for example, approximately 0.5 inch, and adjacent LowerAccess Openings 36L within an Lower Opening Group 36GL are separated, in the direction along the Dispenser 16, by a Lower Separator Bar 36BL having a width of approximately 0.1 inch. In the direction measured across a Dispenser 16, that is, from Dispenser Sidewall 16S to the adjacent Side Wall 26 of the Seed Container 12, the distance between an edge of a Lower Access Opening 36L and the same edge of the adjacent Lower Access Opening 36L is approximately 0.5 inch, and adjacent Lower Access Openings 36L within a Lower Opening Group 36GL are separated, in the direction across the Dispenser 16, by a Lower Separator Bar 36BL having a width of approximately 0.1 inch. Lastly, adjacent Lower Opening Groups 36GL are spaced apart along the length of the Dispenser 16 by approximately 0.5 inches, leaving a space of approximately 0.50 inch between each Upper Opening Group 36GL and the corresponding End Wall 16E. Again, Lower Separator Bars 36BL are, in the present embodiment, formed of the Lower Guard Plate 36GM material remaining after Lower Access Openings 36L have been cut into the Lower Guard Plate 16GL and form a grid.

Next considering Upper Guard Plate 16U and Lower Guard Plate 16L in conjunction, and referring to FIGS. 2, 3,4 and 5, each Upper Opening Group 36GU is located vertically above the corresponding Lower Opening Group 36GL, or, stated in the reverse, each Lower Opening Group 36GL is located vertically below the corresponding Upper Opening Group 36GU. The dimensions, that is, the length and width, of each Lower Opening Group 36GL and of the corresponding Upper Opening Group 36GU are equal, or approximately so. In addition, the dimensions and inter-opening dimensions of each Lower Access Opening 36L are approximately one half of those of an Upper Access Opening 36U, so that there is a group of four Lower Access Openings 36L corresponding to each Upper Access Opening 36U. Also, the location and dimensions each group of four Lower Access Openings 36L correspond with those of the corresponding Upper Access Opening 36U.

For purposes of simplicity of fabrication and assembly, the top of each Dispenser 16 is formed of and by the corresponding Upper Guard Plate 16GU and each Upper Guard Plate 16GU is formed together with the corresponding Side Wall 26 as a single plate, which is then bent to the appropriate angle along the junction between Upper Guard Plate 16GU and the Side Wall 26. In the exemplary embodiment illustrated in FIGS. 2, 3 and 4, Upper Guard Plate 16GU is approximately 2¼ or 2½ inches wide from Side Wall 26 of Seed Container 12 to Dispenser Sidewall 16S, and the Side Wall 26 portion of the plate is approximately four inches high. The Dispenser Sidewall 16S is approximately 1½ to 2 inches high, so that Upper Guard Plate 16GU is thereby located approximately 1½ to 2 inches above the bottom plate of the Dispenser 16. As shown, the outer edge of Upper Guard Plate 16GU is formed into a downwardly offset Guard Interlock Lip 16GI that extends along at least part of the length of Upper Guard Plate 16GU and that engages with a horizontally extending Sidewall Interlock Lip 26SI formed at the top edge of Sidewall 6 and that extends along at least part of the length of Sidewall 26. As shown, when Guard 16G is in the finally assembled position the top of Guard Interlock Lip 16GI engages against the lower surface of Sidewall Interlock Lip 26SI so that Guard Interlock Lip 16GI is trapped under Sidewall Interlock Lip 26SI, thereby locking the assembly that includes Guard 16G and Sidewall 26 into the desired structural relationship with Dispenser 16 and Dispenser Sidewall 16S.

Although not necessary to the present discussion, it may be noted that the Feeder 10, and Seed Container 12, the Dispensers 16 and Upper Guard Plate 16GU and Lower Guard Plate 16GL, are about 12 inches long. It will be recognized, however, that these and other stated dimensions for the exemplary embodiment of a Feeder 10 are intended to be solely illustrative and exemplary, and that other dimensions may be employed according to the choice and desire of the designer.

As discussed previously, the Side Wall 26 portion of the plate that includes Upper Guard Plate 16GU also includes a plurality of Window Openings 340 and associated Brackets 34B for retaining one or more Transparent Plates 34P forming Windows 34. In the present embodiment, the Windows 34 on each side of Seed Container 12 are formed by a single, common Transparent Plate 34P extending approximately the length of the side of Seed Container 12. A single Bracket 34B is located at each end of each Side Wall 26 to retain the corresponding end of the Transparent Plate 34P against the Side Wall 26 and is formed, for example, by rolling or bending the corresponding vertical edge of End Wall 24 to form the Bracket 34B. As will be described below, the lower edge of each Transparent Plate 34P is supported and retained by a Bracket 34B formed in and along an upper horizontal edge of Side Wall Extension 26E and is also formed, for example, by rolling or bending the edge of the portion of Lower Guard 16GL forming the Side Wall Extension 26E to form the Bracket 34B.

In addition, and as will also be discussed below, a Sidewall Bracket 26B is formed in the upper portion of the vertical edge of each End Wall 24 to retain each Side Wall 26 in the desired position with respect to the End Wall 24. In summary, therefore, each side of Seed Container 12 is formed of a “sandwich” of a single Transparent Plate 34P and a Side Wall 26, each vertical end of the “sandwich” being trapped and retained between the corresponding vertical Bracket 34B on the inside and the corresponding Sidewall Bracket 26B on the outside. As described, the Transparent Plate 34P on each side of Seed Container 12 is supported vertically by the Bracket 34B running along the top edge of the corresponding Lower Guard 16GL.

Lastly, and as shown, the top corners of the Side Wall 26 are formed to receive and retain the corresponding Rod 30R. Also, and as will be discussed in a following discussion of the assembly and disassembly of a Feeder 10, in the present embodiment the length of Side Wall 26 and Guard 16G are slightly less than the distance between End Walls 24, the gap between Side Walls 26 and End Walls 24 being effectively closed by Brackets 34B and Transparent Plate 34P.

Next considering Lower Guard Plate 16GL, and FIGS. 2 and 5, the Lower Guard Plate 16GL is approximately the same length and width of Upper Guard Plate 16GU and extends along Dispenser 16 above Seed Reservoir 14R and, again for simplicity of fabrication and assembly, is formed from a single plate that includes the Lower Guard Plate 16GL, a Lower Guard Plate Support 16SL and a Side Wall Extension 26E. As shown, the single plate is bent upward along the line of intersection between the plane of the Lower Guard Plate 16GL and the plane of the Side Wall 26 to form the Side Wall Extension 26E and is bent downwards along the line of intersection between the plane of the Lower Guard Plate 16GL and the plane of the outer Dispenser Sidewall 16S of the Dispenser 16 to form the Lower Guard Plate Support 16SL. The width of the Lower Guard Plate 16GL is approximately the same as that of the Upper Guard Plate 16GU, approximately 2¼ or 2½ inches wide from Side Wall 26 of Seed Container 12 to Dispenser Sidewall 16S. Side Wall Extension 26E has a height of approximately 1.5 inches, and Lower Guard Plate Support 16SL has a height of approximately 0.5 to 0.75 inch; that is, the height necessary to extend from Lower Guard Plate 16GL approximately to Bottom Plate 16B.

As shown, the upper edge of Side Wall Extension 26E is attached to the lower edge of the Side Wall 26 by a Side Wall Fastening 26F, which may be, for example, rivets, spot welding, nuts and bolts, or appropriate screws, so that Lower Guard Plate 16GL extends horizontally approximately 1 inch below Upper Guard Plate 16GU and about 0.5 to 0.75 inch above the Bottom Plate 16B of the Dispenser 16 and Bottom Panel 28B of the Seed Container 12. The gap extending between the bottom edge of Side Wall Extension 26E and the bottom plate of Seed Container 12 and the Dispenser 16 and extending the length of Seed Container 12 and the Dispenser 16 thereby forms a Flow Path 22 having a height of between approximately 0.4-0.5 inch to about 1.0 inch, and preferably of about 0.66 to 0.70 inches high.

The Flow Path 22 between the Seed Container 12 and the Dispenser 16 thereby allows Seed 14 to slide downwards from Seed Container 12 and along the sloping bottom plate of Seed Container 12 and the Dispenser 16 and into the Seed Reservoir 14R of Dispenser 16. As Seed Reservoir 14R is preferably formed entirely below the level of Lower Guard Plate 16GL, Seed Reservoir will have a depth, for example, of approximately 0.5 inch or less. In this regard, it should be noted that the bottom plates of Seed Container 12 and of Dispensers 16 may be comprised of separate plates. For simplicity of fabrication and assembly, however, and to provide a smooth path for the flow of Seed 14, the bottom plates of the Dispensers 16 and the bottom plate of the Seed Container 12 are formed of a single Bottom Plate 12B bent to the appropriate contour to accommodate the shape and dimensions of the lower edges of End Walls 24.

D. Operation of a Squirrel Guard

Next considering the operation of a Guard 16G in further detail, as has been described, the function and purpose of a Guard 16G is to limit or frustrate the theft of Seed 14 from a Feeder 10 by undesired wildlife, and in particular by squirrels, while permitting desired wildlife, such as birds or certain species of birds, to access the Seed 14. For this reason, the dimensions and spacings of Upper and Lower Access Openings 36U and 36L are designed to permit at least desired species of birds to reach through an Upper and Lower Access Openings 36U and 36L to seize and withdraw Seed 14.

With regard to protecting the Seed 14 from, for example, squirrels, the present invention recognizes that while squirrel's paws, and in particular their front paws, are relatively dexterous, squirrels do not have opposable thumbs and thus have difficulty grasping smaller objects, such as seeds, with only one paw. As such, squirrels are generally forced to grasp seeds with both paws in order to remove the seeds from a bird feeder. According to the present invention, the preferred arrangement, dimensions and spacing of the guard plates and access openings in the dispenser guard described herein above therein are selected according to the average shoulder width and forearm length of common squirrels to interfere with their grasping of seeds with both fore-paws.

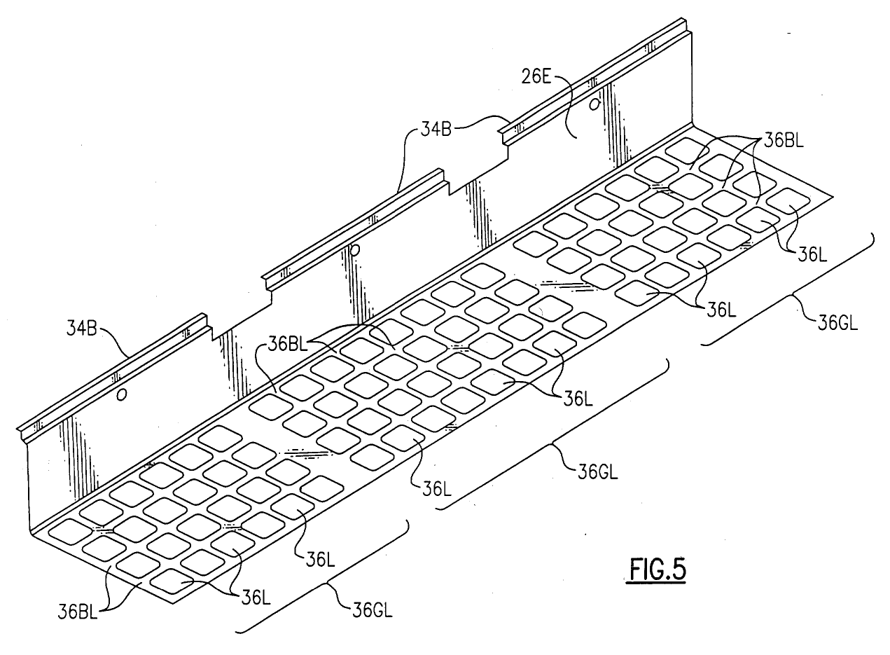

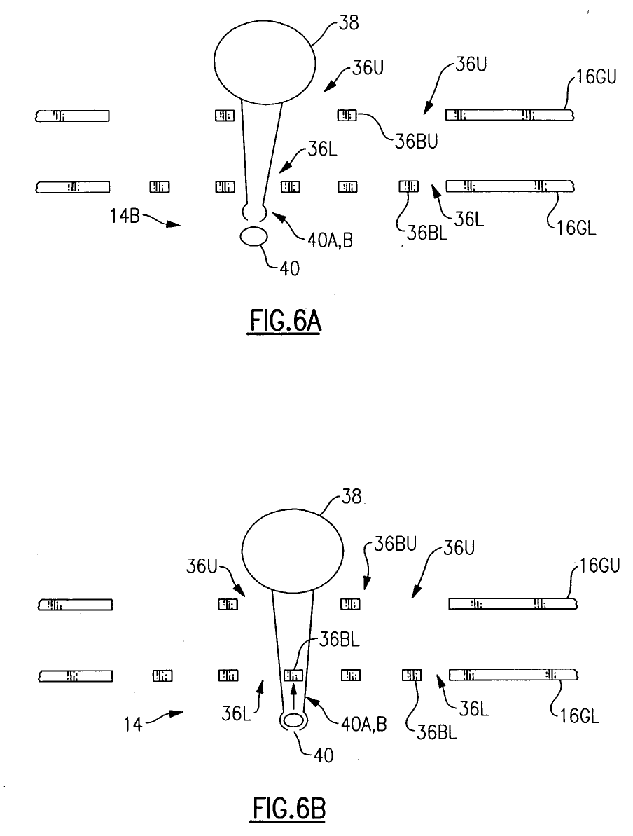

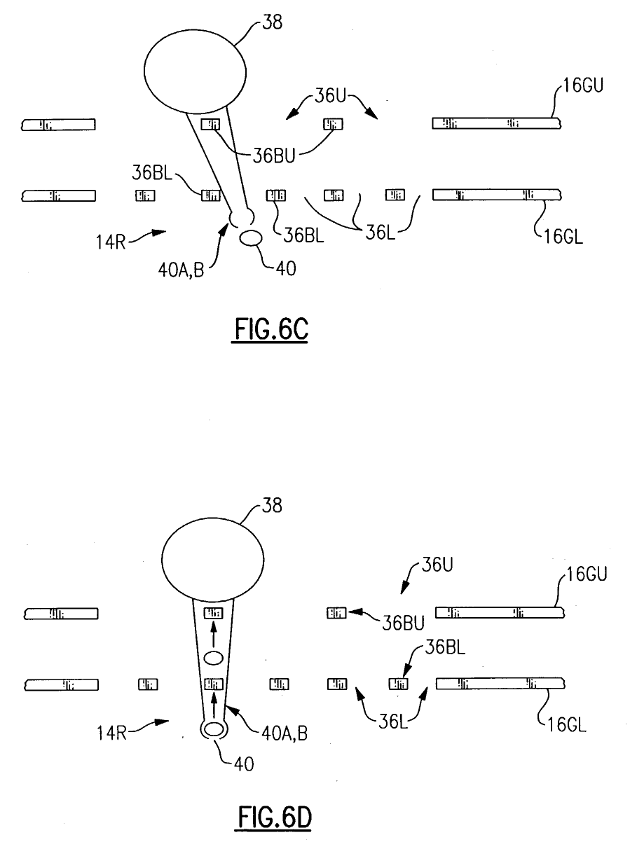

Referring to FIGS. 2 and FIGS. 6A, 6B, 6C and 6D, each of FIGS. 6A, 6B, 6C and 6D is a diagrammatic representation of sectional view along a part of the length of a Dispenser 16 as viewed, for example, looking outwards from the Seed Container 12. FIGS. 6A, 6B, 6C and 6D therefore diagrammatically illustrate the relationship between Upper and Lower Guard Plates 16GU and 16LU, Upper and Lower Access Openings 36U and 36L, and Upper and Lower Separator Bars 36BU and 36BL, and illustrate possible ways in which a Squirrel 38 may attempt to grasp a Seed 40 through the Guard 16G.

As illustrated in FIGS. 6A and 6B, a Squirrel 38 may attempt to insert its Paws 40A and 40B through a single Upper Access Opening 36U, that is, between adjacent Upper Separator Bars 36BU. As illustrated in FIG. 6A, the Squirrel 38 may then attempt to pass its Paws 40A and 40B through a single Lower Access Opening 36L, between adjacent Lower Separator Bars 36BL, and into Seed Reservoir 14R in the attempt to grasp a Seed 40. In the alternative, as illustrated in FIG. 6B, the Squirrel 38 may attempt to pass its Paws 40A and 40B through separate but adjacent Lower Access Openings 36L, on either side of a Lower Separator Bar 36BL, in the attempt to grasp a Seed 40 in Seed Reservoir 14R.

It may be seen in the approach illustrated in FIG. 6A that the width of the Upper Access Opening 36U, which is based upon the shoulder width of an average squirrel, will tend to force the Squirrel 38's fore-paws together, thus limiting the mobility of the fore-paws. The lesser width of the Lower Access Opening 36U will then tend to prevent the Squirrel 38 from separating its fore-paws by a distance sufficient to allow the Squirrel to grasp the Seed 40 and, in effect, will tend to “handcuff” the Squirrel.

In the alternative approach illustrated in FIG. 6B, the width of the Upper Access Opening 36U will again tend to force the Squirrel 38's fore-paws together, again limiting the mobility of its fore-paws. When the Squirrel 38 passes its fore-paws through two, adjacent Lower Access Openings 36L, however, its fore-paws will not be “handcuffed” by the lesser width of the Lower Access Openings 36L to the same degree as in FIG. 6A. Instead, however, the Lower Separator Bar 36BL will pass between its fore-paws so that while the Squirrel 28 may be able to grasp a Seed 40 between its fore-paws, it will not be able to withdraw its fore-paws with the Seed 40. That is, the Lower Separator Bar 36BL is in effect caught in the loop formed by the fore-paws and the Seed 40 and will block the removal of the Seed 40 so that the Squirrel 38 can withdraw its paws only by letting go of the Seed 40.

In other approaches illustrated in FIGS. 6C and 6D, a Squirrel 38 may attempt to insert its Paws 40A and 40B through adjacent Upper Access Openings 36U, that is, on either side of an Upper Separator Bars 36BU. As illustrated in FIG. 6C, the Squirrel 38 may then attempt to pass its Paws 40A and 40B through a single Lower Access Opening 36L, between adjacent Lower Separator Bars 36BL, and into Seed Reservoir 14R in the attempt to grasp a Seed 40. In the alternative, and as illustrated in FIG. 6D, the Squirrel 38 may attempt to pass its Paws 40A and 40B through adjacent Lower Access Openings 36L, on either side of a Lower Separator Bar 36BL, in the attempt to grasp a Seed 40 in Seed Reservoir 14R.

The approach illustrated in FIG. 6C, however, comes to the same result as the approach illustrated in FIG. 6A. That is, the lesser width of the Lower Access Opening 36U will tend to prevent the Squirrel 38 from separating its fore-paws by a distance sufficient to allow the Squirrel to grasp the Seed 40 and, in effect, will tend to “handcuff” the Squirrel. It should also be noted, however, that even if the Squirrel 38 should succeed in grasping a Seed 40, and maneuvering it through the Lower Access Opening 36L, there will be an additional obstacle in that the Squirrel 38 will also have to maneuver the Seed 40 past the Upper Separator Bar 36BU.

The approach illustrated in FIG. 6D, in turn, comes to a result similar to that illustrated in FIG. 6B. That is, its fore-paws will not be “handcuffed” by the lesser width of the Lower Access Openings 36L to the same degree as in FIG. 6A, but the Lower Separator Bar 36BL will block the removal of the Seed 40 so that the Squirrel 38 can withdraw its paws only by letting go of the Seed 40. It should also be noted that the Squirrel 38 again faces an additional obstacle even if it should maneuver a Seed 40 past the Lower Separator Bar 36BL in that it will also have to maneuver the Seed 40 past the Upper Separator Bar 36BU, although this may be easier than bypassing the Lower Separator Bar 36BL.

Lastly, it must be noted with respect to all of the above situations that the distance between Upper Access Openings 36U and Lower Access Openings 36L, that is, between Upper Guard Plate 36GU and Lower Guard Plate 36GL, is such compared to the forearm length of an average Squirrel 38 as to at least handicap the Squirrel 38's reach in the lateral direction. In addition, this distance may be sufficient to prevent at least some Squirrels 38 from reaching the Seed Supply 14S in Seed Reservoir 14R.

E. Assembly, Disassembly and Cleaning of a Feeder and Squirrel Guard

It will be noted from the above discussions that with the exception of Side Wall Fastenings 26F and Rods 30R the presently preferred embodiments of a Feeder 10 with a Guard 16G do not employ fasteners, such as bolts or screws in either the original fabrication and assembly of the Feeder 10 or in subsequent disassembly and reassembly of the Feeder 10 for cleaning purposes.

More specifically, and as discussed herein above, each Side Wall 26 and corresponding Guard 16G are fabricated as a single unit, which is identified in FIGS. 2 and 3 as Wall/Guard Assembly 42. As described and shown, a Wall/Guard Assembly 42 is comprised of a Side Wall 26 with an Upper Guard Plate 16GU that is formed as a part of the Side Wall 26 and a Lower Guard Plate 16GL that is permanently attached to Side Wall 26 by means of the Side Wall Extension 26E, which is formed as a part of Lower Guard Plate 16GL. As illustrated in FIG. 3, each Side Wall 26 is in turn a part of a Wall Sandwich 44 having two layers wherein the outer layer is comprised of the Side Wall 26 and the inner layer is comprised of a corresponding Transparent Plate 34P located against the inside face of the Side Wall 26.

A Bracket 34B is formed from or attached to the End Wall 24 at each end of the Side Wall 26 and extends along the inside surface of the Transparent Plate 34P to both retain the Transparent Plate 34P against the Side Wall 26 and to determine an inner limit of the location of the inner side of the Wall Sandwich 44, that is, an inner limit for the location of the inner surface of the Transparent Plate 34P. The lower edge of the Transparent Plate 34P is likewise supported and retained by a Bracket 34B formed in or attached to the upper horizontal edge of Side Wall Extension 26E, thereby similarly determining an inner limit for the location of the inner side of the Wall Sandwich 44, that is, an inner limit for the location of the inner surface of the Transparent Plate 34P.

As shown and described, a Sidewall Bracket 26B is formed in the upper portion of the vertical edge of each End Wall 24 to bear against and retain the outer surface of the Side Wall 26, that is, the outer surface of the Wall Sandwich 44, thereby determining an outer limit for the location of the upper portion of the Wall Sandwich 44 with respect to the End Wall 24.

The spacing between the Bracket 34B and the corresponding Sidewall Bracket 26B at each end of each Side Wall 26 is determined by and is slightly larger than the thickness of the Wall Sandwich 44, which the combined thickness of the Transparent Plate 34P and the Side Wall 26. As a consequence, the Wall Sandwich 44 is removably but securely retained by the Brackets 34B and the Sidewall Brackets 26B when the Wall Sandwich 44 of the Transparent Plate 34P and Side Wall .26 are assembled and inserted into the gap or slot formed by the Brackets 34B and the Sidewall Brackets 26B. Brackets 34B and Sidewall Brackets 26B thereby also determine the location of the upper portion of the Wall Sandwich 44, that is, the upper portion of Wall/Guard Assembly 42, with respect to each End Wall 24, and secure the upper portion of Wall/Guard Assembly 42 in this position.

The location of the lower portion of Wall/Guard 42 is in turn determined by the interlocking structural relationship between Guard 16G and Dispenser 16. That is, and in particular, Guard Interlock Lip 16GI formed into Upper Guard Plate 16GU engages and interlocks with Sidewall Interlock Lip 26SI formed in Dispenser Sidewall 16S, thereby determining outer and upper limits for the position of the lower portion of Wall/Guard 42, while Lower Guard Plate Support 16SLbearing against Bottom Plate 16B of the Dispenser 16 determines a lower limit on the position of Wall/Guard 42.

In the assembly of a Wall/Guard 42 with Feeder 10, therefore, the upper portion of Side Wall 26 is fitted or slid into the gap or slot between the Brackets 34B on each End Wall 24 and the Sidewall Bracket 26B on each End Wall 24 and the Side Wall 26 is rotated into approximately its final position, that is, with the upper portion of Side Wall 26. generally resting against Sidewall Bracket 26B and Lower Guard Plate Support 16SL resting on Bottom Plate 16B and in general proximity to Dispenser Sidewall 16S. The Transparent Plate 34P is then slid into the slot or gap between the Brackets 34B and Sidewall Brackets 26B and the inner surface of Side Wall 26. The Transparent Plate 34P will thereby urge the upper portion of the Side Wall 26 outwards to contact the Sidewall Brackets 26B, and thus into its final position, while the ends and lower edge of the inner surface of the Transparent Plate 34P will rest against Brackets 34B. The insertion of Transparent Plate 34P into Brackets 34P will also result in the lower portion of the Wall/Guard Assembly 42, that is, Sidewall Extension 26E and Guard 16G, being urged or pushed outwards until Lower Guard Plate Support 16SL is in contact with or close proximity to Dispenser Sidewall 16S and until Guard Interlock Lip 16GI engages with Sidewall Interlock Lip 26SI. At this point the Wall/Guard Assembly 42 is positioned and retained in its final assembled location and the Roof 30 may be attached to End Walls 24, or closed, as necessary.

It will be understood by those of ordinary skill in the relevant arts that the above assembly procedure may be reversed to disassemble one or both Wall/Guard Assemblies 42 from the Feeder 10, such as for cleaning purposes. That is, to disassemble a Wall/Guard Assembly 42 the Roof 30 is opened or removed and the Transparent Plate 34P is removed from the gap or slot between the Brackets 34B and Sidewall Brackets 26B and the inner surface of Side Wall 26. The lower portion of the Wall/Guard Assembly 42 is then moved inwards sufficiently to disengage Guard Interlock Lip 16GI from Sidewall Interlock Lip 26SI and Wall/Guard Assembly 42 is moved upwards sufficiently so that Guard 16G, including Lower Guard Plate Support 16SL, is free of Dispenser 16. Wall/Guard Assembly 42 may then be rotated as necessary to allow the upper portion of Wall/Guard Assembly 42 to be withdrawn from the space between the upper end of the Brackets 34B on End Walls 24 and Sidewall Brackets 26B, whereupon Wall/Guard Assembly 42 is disassembled from the Feeder 10. The Wall/Guard Assembly 42 may then be again reassembled to the Feeder 10 by the assembly steps described above.

Lastly, it should be noted with regard to the above described assembly and disassembly of Wall/Guard Assemblies 42 that in the exemplary embodiment the length of Side Walls 26 and Guards 16G are slightly less than the distance between End Walls 24, thereby allowing Wall/Guard Assembly 42 to be rotated and slid into and out of engagement with the remaining elements of the Feeder 10, such as End Walls 24 and the walls and sides of Dispensers 16. In these implementations, the resulting gaps between Side Walls 26 and End Walls 24 at the corners of Seed Container 12 are effectively closed by Brackets 34B and Transparent Plate 34P, so that Seed 14 is not lost by leakage from Seed Container 12 through these gaps.

F. Conclusion

It will be recognized and understood, in particular after the above discussions, that the dimensions and design of a Feeder 10, including one or more Dispensers 16 and of a Guard 16G may vary significantly, depending upon the detail design and dimensions of a given Feeder 10. For example, the number, arrangement and spacings of Upper Access Openings 36U and Lower Access Openings 36L and the dimensions and spacings of Upper Guard Plates 16U and Lower Guard Plate 16L may vary significantly. For example, in the present embodiment adjacent Upper and Lower Access Openings 36U or 36L are spaced apart by Upper and Lower Separator Bars 36BU or 36BL that are relatively narrow compared to the width of the access openings and the access openings are cut out of the material of the Upper and Lower Guard Plates 16U and 16L. In other embodiments, for example, the spacing between the access openings, that is, the widths of the separator bars, may be greater, the number of access openings reduced or increased, the upper and lower access openings may be arranged in different patterns, and the dimensions of the guard and dispenser and number of dispensers may be varied. In yet other embodiments, Upper and/or LowerAccess Openings 36U/36L may be fabricated as single, larger openings and Upper and/Lower Separator Bars 36BU/36BL fabricated of wire or rod of a suitable diameter, so that the organization, dimensions and separations between the access openings are defined by the separator bars. In general, however, the dimensions and relative locations of the upper and lower access openings and the spacing between the upper and lower guard plates should preferably be in the approximate ranges described in the exemplary embodiment described herein. It will be recognized by those of ordinary skill in the arts, however, that these dimensions may vary according to the needs or requirements of a specific design. For example, the exemplary embodiment of a Guard 16G described herein is designed according to the average dimensions of an average grey squirrel, but may be reduced, for example, for red squirrels as red squirrels tend to be smaller than grey squirrels, or to accommodate larger or smaller species of birds. The design of a Feeder 10 and a Guard 16G should, however, preferably be dimensioned according to the principles discussed herein.

Since certain changes may be made in the above described invention without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A dispenser guard for use in a bird feeder including a seed storage and a seed dispenser having a seed reservoir connected from the seed storage for receiving seed from the seed storage and allowing access to the seed, the guard comprising:
an upper guard plate extending across the seed reservoir and including a first plurality of upper access openings, and
a lower guard plate located between the upper guard plate and the seed reservoir and extending across the seed reservoir and including a second plurality of lower access openings, wherein
the dimensions of the lower access openings are less than the dimensions of the upper access openings and the dimensions of the upper and lower access openings and the distance between the upper guard plate and the lower guard plate are selected to prevent a squirrel from removing a seed from the reservoir through an upper access opening and a lower access opening.

2. The dispenser guard of claim 1, wherein:
the dimensions of the upper and lower access openings and the distance between the upper guard plate and the lower guard plate are selected to allow a desired species of bird access to the seed in the seed reservoir.

3. The dispenser guard of claim 1, wherein:
the dimensions of the upper access openings are selected to be less than the shoulder width of an average squirrel, and
the dimensions of the lower access openings are less than the dimensions of the upper access openings and the dimensions of the upper and lower access openings and the distance between the upper guard plate and the lower guard plate are selected according to the forearm length of an average squirrel to prevent an average squirrel from removing a seed from the reservoir when the squirrel paws are thrust through an upper access opening and a lower access opening.

4. The dispenser guard of claim 1, wherein the lower access openings are arranged into at least one third plurality of lower access openings, each third plurality of upper access openings corresponding to an upper access opening and having dimensions corresponding to the dimensions of the corresponding upper access opening.

5. The dispenser guard of claim 4, wherein each third plurality of lower access openings is located vertically below the corresponding upper access opening.

6. The dispenser guard of claim 4, wherein the upper access openings are arranged as one or more groups of upper access openings and each third plurality of lower access openings is arranged as a corresponding group of lower access openings.

7. The dispenser guard of claim 3 wherein the average squirrel is a grey squirrel.

8. A bird feeder, comprising:
a seed storage,
at least one seed dispenser having a seed reservoir connected from the seed storage for receiving seed from the seed storage and allowing access to the seed, and
for each dispenser, a guard interfering with the removal of seed from a seed reservoir by a squirrel, each guard including
an upper guard plate extending across the seed reservoir and including a first plurality of upper access openings, and
a lower guard plate located between the upper guard plate and the seed reservoir and extending across the seed reservoir and including a second plurality of lower access openings, wherein
the dimensions of the lower access openings are less than the dimensions of the upper access openings and the dimensions of the upper and lower access openings and the distance between the upper guard plate and the lower guard plate and are selected to prevent a squirrel from removing a seed from the reservoir when the squirrel paws are thrust through an upper access opening and a lower access opening.

9. The bird feeder of claim 8, wherein:
the dimensions of the upper and lower access openings and the distance between the upper guard plate and the lower guard plate are selected to allow a desired species of bird access to the seed in the seed reservoir.

10. The bird feeder of claim 8, wherein:
the dimensions of the upper access openings are selected to be less than the shoulder width of an average squirrel, and
the dimensions of the lower access openings are less than the dimensions of the upper access openings and the dimensions of the upper and lower access openings and the distance between the upper guard plate and the lower guard plate and are selected according to the forearm length of an average squirrel to prevent an average squirrel from removing a seed from the seed reservoir when the squirrel paws are thrust through an upper access opening and a lower access opening.

11. The bird feeder of claim 8, wherein the lower access openings are arranged as at least one third plurality of lower access openings, each third plurality of lower access openings corresponding to an upper access opening and the dimensions of each third plurality of lower access openings corresponds to the dimensions of the corresponding upper access opening.

12. The dispenser guard of claim 11, wherein each third plurality of lower access openings is located vertically below the corresponding upper access opening.

13. The dispenser guard of claim 11, wherein the upper access openings are arranged as one or more groups of upper access openings and each third plurality of lower access openings is arranged as a corresponding group of lower access openings.

14. The dispenser guard of claim 9 wherein the average squirrel is a grey squirrel.

15. A bird feeder, comprising:
a seed storage, including
first and second side walls,
first and second end walls,
a roof, and
a container floor plate,
at least one seed dispenser having a seed reservoir connected from the seed storage for receiving seed from the seed storage and allowing access to the seed,
each dispenser including
a reservoir floor plate continuous with the container floor plate, and
a guard interfering with the removal of seed from the seed reservoir by a squirrel, including
an upper guard plate, including
a first upper guard plate panel extending across the seed reservoir and including a first plurality of upper access openings, and
a second upper guard plate panel extending from the first guard plate panel and forming a side wall of the seed container, and
a lower guard plate including
a first lower guard plate panel located between the first upper guard plate panel and the seed reservoir and extending across the seed reservoir and including a second plurality of lower access openings, and
a second lower guard plate panel extending upwards from the first lower guard plate panel and forming a side wall extension, a top edge of the side wall extension being attached to a bottom edge of the side wall, wherein
a gap between a bottom edge of the side wall extension and the reservoir floor plate forms a seed flow path from the seed container into the reservoir, and wherein
the dimensions of the lower access openings are less than the dimensions of the upper access openings and the dimensions of the upper and lower access openings and the distance between the upper guard plate and the lower guard plate and are selected to prevent a squirrel from removing a seed from the seed reservoir.

16. The bird feeder of claim 15, wherein:
the dimensions of the upper and lower access openings and the distance between the upper guard plate and the lower guard plate are selected to allow a desired species of bird access to the seed in the seed reservoir.

17. The bird feeder of claim 15, wherein:
the dimensions of the lower access openings and the distance between the upper guard plate and the lower guard plate and are selected according to the forearm length and shoulder width of an average squirrel to prevent an average squirrel from one of separating its paws to grasp a seed and avoid trapping one of an upper and a lower guard plate element between the squirrel paws when the squirrel paws are thrust through an upper access opening and a lower access opening.

18. The bird feeder of claim 15, wherein the lower access openings are arranged as at least one third plurality of lower access openings, each third plurality of lower access openings corresponding to an upper access opening and the dimensions of each third plurality of lower access openings corresponding to the dimensions of the corresponding upper access opening.

19. The dispenser guard of claim 18, wherein each third plurality of lower access openings is located vertically below the corresponding upper access opening.

20. The dispenser guard of claim 18, wherein the upper access openings are arranged as one or more groups of upper access openings and each third plurality of lower access openings is arranged as a corresponding group of lower access openings.

21. The dispenser guard of claim 16 wherein the average squirrel is a grey squirrel.

22. A bird feeder, comprising:
a seed storage, including first and second side walls, first and second end walls, a roof, and a container floor plate,
each side wall having at least one window opening, and
each end wall having a window bracket for engagingly retaining a transparent panel against an inner surface of the side wall and a sidewall bracket for engagingly retaining an upper edge of the side wall and the transparent panel against the window bracket,
at least one seed dispenser having a seed reservoir connected from the seed storage, each dispenser including an outer wall, a reservoir floor plate and a squirrel guard,
each guard being fabricated as a single unit with a container side wall and including
an upper guard plate, including a first upper guard plate panel extending across the seed reservoir, and
a second upper guard plate panel forming a side wall of the seed container, and
a lower guard plate including
a first lower guard plate panel extending across the seed reservoir between the first upper guard plate panel and the seed reservoir and having an outer edge removably engaging with an upper edge of the outer wall of the seed reservoir,
a second lower guard plate panel extending downwards from the outer edge of the first lower guard plate panel to the reservoir floor plate, and
a third lower guard plate panel forming a side wall extension, a top edge of the side wall extension being attached to a bottom edge of the side wall and formed into a bracket for engagingly retaining a lower edge of the transparent panel, wherein
a gap between a bottom edge of the side wall extension and the reservoir floor plate forms a seed flow path from the seed container into the reservoir, and wherein
the first upper guard plate panel includes a first plurality of upper access openings and the first lower guard plate panel includes a second plurality of lower access openings wherein the dimensions of the upper and lower access openings and the distance between the upper guard plate and the lower guard plate and are selected to prevent a squirrel from removing a seed from the seed reservoir.

23. The bird feeder of claim 22 wherein:
a guard and container side wall unit are slidably and rotatingly engaged with the bird feeder by
engagement of the upper edge of the side wall between a window bracket and a sidewall bracket,
engagement of the outer edge of the first lower guard plate panel with the upper edge of the outer wall of the seed reservoir, and
location of the transparent panel between the inner surface of the side wall and the window bracket and in contact with the window bracket to urge the top edge of the side wall into contact with the sidewall bracket, to urge the outer edge of the first lower guard plate into contact with the upper edge of the outer wall of the seed reservoir.

24. The bird feeder of claim 22, wherein:
the dimensions of the lower access openings are less than the dimensions of the upper access openings and the dimensions of the upper and lower access openings and the distance between the upper guard plate and the lower guard plate are selected to allow a desired species of bird access to the seed in the seed reservoir.

25. The bird feeder of claim 22, wherein:
the dimensions of the lower access openings and the distance between the upper guard plate and the lower guard plate and are selected according to the forearm length and shoulder width of an average squirrel to prevent an average squirrel from one of separating its paws to grasp a seed and avoid trapping one of an upper and a lower guard plate element between the squirrel paws when the squirrel paws are thrust through an upper access opening and a lower access opening.

26. The bird feeder of claim 22, wherein the lower access openings are arranged as at least one third plurality of lower access openings, each third plurality of lower access openings corresponding to an upper access opening and the dimensions of each third plurality of lower access openings corresponding to the dimensions of the corresponding upper access opening.

27. The dispenser guard of claim 26, wherein each third plurality of lower access openings is located vertically below the corresponding upper access opening.

28. The dispenser guard of claim 26, wherein the upper access openings are arranged as one or more groups of upper access openings and each third plurality of lower access openings is arranged as a corresponding group of lower access openings.
